(19) United States
(12) Patent Application Publication
(10) Pub. No.: US 2023/0175692 A1
(43) Pub. Date: Jun. 8, 2023

(54) DOME-INTEGRATED ACOUSTIC DAMPER FOR GAS TURBINE COMBUSTOR APPLICATIONS

(71) Applicants: GE Avio S.r.l., Rivalta di Torino (IT); General Electric Company Polska sp. z o.o, Warsaw (PL); General Electric Deutschland Holding GmbH, Frankfurt (DE)

(72) Inventors: Krzysztof Kostrzewa, Fahrenzhausen (DE); Roberto Ferraro, Torino (IT); Krzysztof Benkiewicz, Brwinów (PL)

(21) Appl. No.: 17/806,116

(22) Filed: Jun. 9, 2022

(30) Foreign Application Priority Data
Dec. 6, 2021 (IT) 102021000030779

(51) Int. Cl. F23M 20/00

(52) U.S. Cl. CPC F23M 20/005; F05B 2260/96; F23R 2900/00013; F23R 2900/00014

(57) ABSTRACT

A combustor includes an annular dome and a plurality of dampers integral with the annular dome. Each of the plurality of dampers includes an adjustable damper cover and a damper portion defining a cavity having a volume. The damper cover is mounted to the damper portion integrated with the annular dome and is movable to adjust the volume of the cavity to adjust a frequency of each of the plurality of dampers to reduce an acoustic amplitude of the combustor.

### CROSS REFERENCE TO RELATED APPLICATIONS

The present application claims the benefit of Italian Patent Application No. 102021000030779, filed on Dec. 6, 2021, which is hereby incorporated by reference herein in its entirety.

### TECHNICAL FIELD

The present disclosure relates generally to combustors and, in particular, to an acoustic damper integrated in a dome of a combustor and a combustor having the acoustic damper.

### BACKGROUND

Engines, and, particularly, gas or combustion turbine engines, are rotary engines that extract energy from a flow of combusted gases passing through the engine onto a multitude of turbine blades. Turbine engines have been used for land and nautical locomotion, and power generation. Turbine engines are commonly used for aeronautical applications such as for aircraft, including helicopters and airplanes. In aircraft, turbine engines are used for propulsion of the aircraft. In terrestrial applications, turbine engines are often used for power generation.

Turbine engines include fuel-air mixer assemblies for mixing fuel and air in a combustion chamber of the turbine engines. The fuel-air mixer assemblies include an air swirler. Combustor performance in the combustion chamber plays an important role in the overall performance of the gas turbine engine.

In the combustion of liquid fuels or gaseous fuels in the combustion chamber of a gas turbine, the fuel and the combustion air are injected separately into a combustor and mixed in the combustion chamber or injected as pre-mixed as uniformly as possible and are then fed into the combustion chamber. In order to take account of environmental considerations, care is taken to have a low flame temperature by means of a substantial excess of air so as to reduce the formation of nitrogen oxides (NOx).

In combustion chambers, due to specific fuel and combustion system architectures, air and fuel flow fluctuations can be generated. These fluctuating quantities can make the flame respond and the so-called thermo-acoustic feedback loop can be established. As a result, large oscillation amplitudes or vibration amplitudes can be generated in which the gas turbine reaches its limit of mechanical loading or stability. To prevent this phenomenon, dampers are used to reduce oscillation or vibration amplitudes. The dampers act as Helmholtz resonators that can be tuned in terms of their damping frequency in accordance with the oscillation amplitude to be damped.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic diagram of a turbine engine, according to an embodiment of the present disclosure.

FIG. 2A is a cross-sectional view of a portion of a combustor of a combustor assembly of the turbine engine, according to an embodiment of the present disclosure.

FIG. 2B is a cross-sectional view of a portion of a combustor of a combustor assembly of the turbine engine, according to another embodiment of the present disclosure.

FIG. 3 is a schematic front view of a segment of the combustor showing a location of a plurality of damper, according to an embodiment of the present disclosure.

FIG. 4 is a schematic back view of the segment of the combustor showing a location of a damper, according to an embodiment of the present disclosure.

FIG. 5 is a schematic side (cross-sectional) view of the segment of the combustor showing a location of a damper of plurality of dampers, according to an embodiment of the present disclosure.

FIG. 6 is a schematic side (cross-sectional) view of the segment of the combustor showing another position of the damper of plurality of dampers, according to an embodiment of the present disclosure.

FIG. 7 is a general plot of an acoustic reflection coefficient of a cavity of the damper versus a target frequency of the damper acting as a Helmholtz resonator, according to an embodiment of the present disclosure.

FIG. 8 is a general plot of an acoustic reflection coefficient of the cavity of the damper versus a target frequency of the damper acting as a Helmholtz resonator for a specific volume of the cavity of the damper, according to an embodiment of the present disclosure.

FIG. 9 is a general plot of acoustic pressure response of the combustor versus a target frequency with and without the plurality of dampers, according to an embodiment of the present disclosure.

### DETAILED DESCRIPTION

Additional features, advantages, and embodiments of the present disclosure are set forth or apparent from consideration of the following detailed description, drawings, and claims. Moreover, it is to be understood that both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and scope of the present disclosure.

In the following specification and the claims, reference may be made to a number “optional” or “optionally” means that the subsequently described event or circumstance may or may not occur, and that the description includes instances in which the event occurs and instances in which the event does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “axial” and “axially” refer to directions and orientations that extend substantially parallel to a centerline of the turbine engine or the combustor. Moreover, the terms “radial” and “radially” refer to directions and orientations that extend substantially perpendicular to the centerline of the turbine engine or the fuel-air mixer assembly. In addition, as used herein, the terms “circumferential” and “circumferentially” refer to directions and orientations that extend arcuately about the centerline of the turbine engine or the fuel-air mixer assembly. As understood herein a turbine engine includes, for example, a turbojet engine, a turboprop engine, a turbofan, or a turboshaft engine.

Embodiments of the present disclosure seek to reduce efficiently acoustic pressure fluctuations by using a tuned air cavity in the form of Helmholtz resonator. By using the tuned air cavity, unexpected occurrence of high acoustic pressure oscillations in the combustion chamber can be reduced. As a result, operational and structural robustness of the combustion chamber can be enhanced. In addition, by providing a small purge air flow, damping performance of the damper cavity can be increased. The embedded damper cavity and damper neck can be fully integrated with the combustor dome structure. The damper cavity is designed in such a way to make the system flow natural. That is, the damper cavity can be designed in such a way that the flow of air is substantially not affected by the presence of the damper cavity.

By integrating an adjustable damper cover and an imbedded damper portion of the damper within the dome structure of the combustion chamber, fewer parts are used and the overall weight of the combustor can be decreased in comparison with conventional damper configurations. The integration can be accomplished by utilizing unused space under the dome structure. The provided damper cover can be configured to enable tuning the frequency of the damper within a certain frequency range. Based on identified unstable frequencies, the damper target frequency can be adjusted and acoustic pressure oscillations can be reduced.

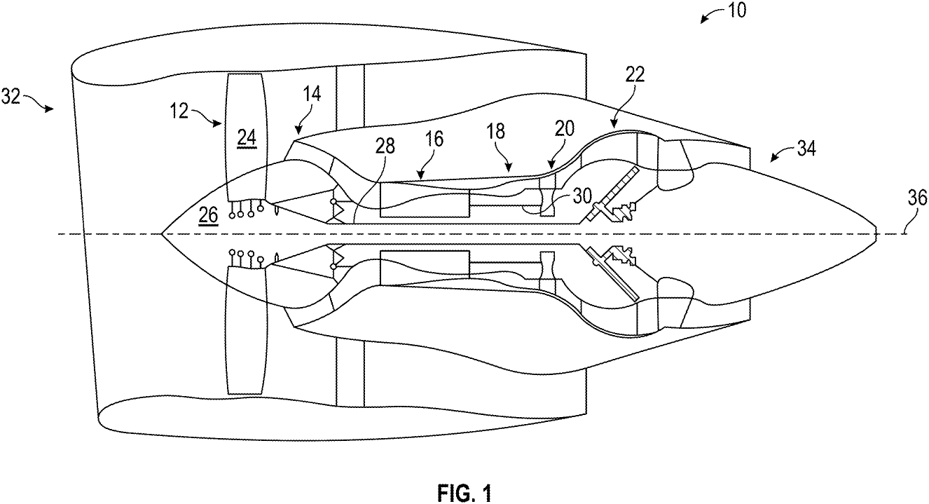

FIG. 1 is a schematic diagram of a turbine engine 10, according to an embodiment of the present disclosure. The turbine engine 10 includes a fan assembly 12, a low-pressure and/or booster compressor (LPC) assembly 14, a high-pressure compressor (HPC) assembly 16, and a combustor assembly 18. Fan assembly 12, booster compressor assembly 14, high-pressure compressor assembly 16, and combustor assembly 18 are coupled in flow communication. Turbine engine 10 also includes a high-pressure turbine assembly 20 coupled in flow communication with combustor assembly 18 and a low-pressure turbine (LPT) assembly 22. Fan assembly 12 includes an array of fan blades 24 extending radially outward from a rotor disk 26. Low-pressure turbine assembly 22 is coupled to fan assembly 12 and booster compressor assembly 14 through a first drive shaft 28, and high-pressure turbine assembly 20 is coupled to high-pressure compressor assembly 16 through a second drive shaft 30. Turbine engine 10 has an intake 32 and an exhaust 34. Turbine engine 10 further includes a centerline (axis) 36 about which fan assembly 12, booster compressor assembly 14, high-pressure compressor assembly 16, and the high-pressure turbine assembly 20 and the low-pressure turbine assembly 22 rotate.

In operation, air entering turbine engine 10 through intake 32 is channeled through fan assembly 12 towards booster compressor assembly 14. Compressed air is discharged from booster compressor assembly 14 towards high-pressure compressor assembly 16. Highly compressed air is channeled from high-pressure compressor assembly 16 towards combustor assembly 18, mixed with fuel, and the mixture of air and fuel is burned within combustor assembly 18. High temperature combustion gas generated by combustor assembly 18 is channeled towards high-pressure turbine assembly 20 and low-pressure turbine assembly 22. Combustion gas is subsequently discharged from turbine engine 10 via exhaust 34.

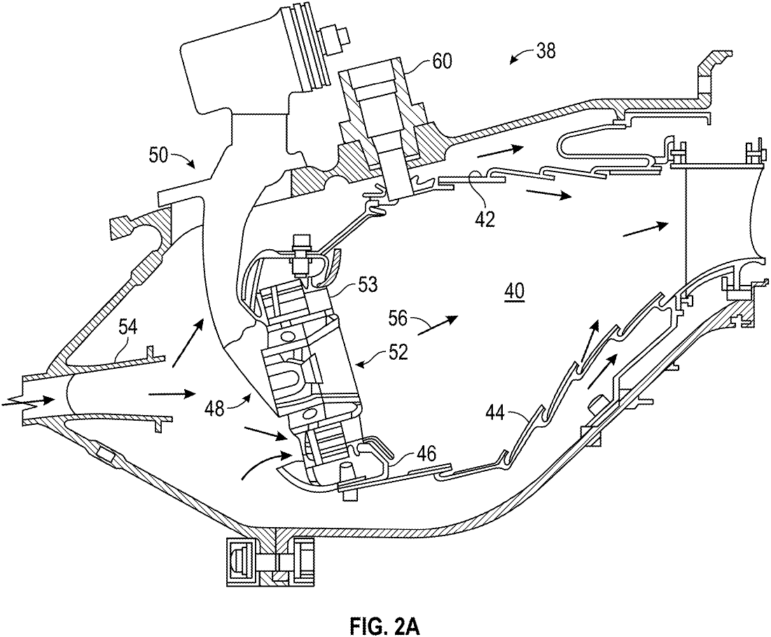

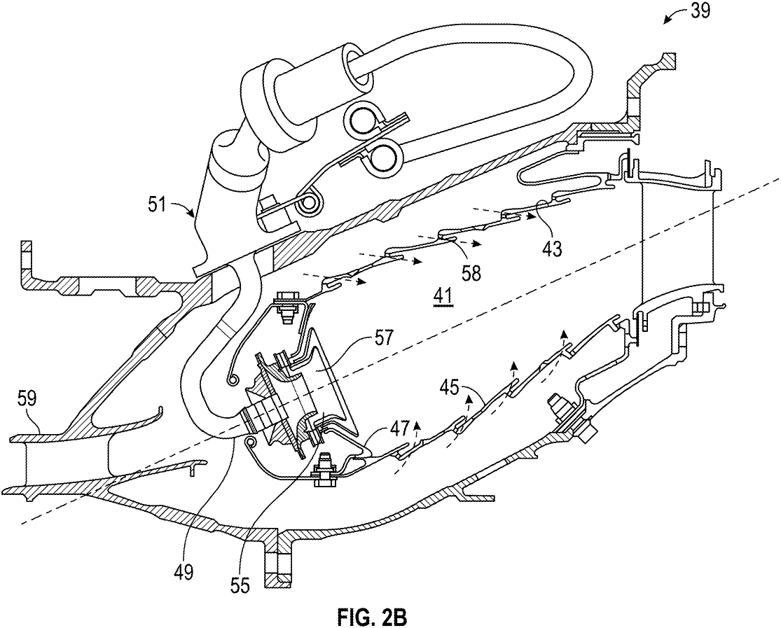

FIG. 2A is a cross-sectional view of a portion of a combustor 38 of combustor assembly 18 of the turbine engine 10 of FIG. 1, according to an embodiment of the present disclosure. The combustor 38 defines a combustion chamber 40 in which fuel is mixed with compressed air and combusted. Combustor 38 includes an outer liner 42 and an inner liner 44. Outer liner 42 defines an outer boundary of the combustion chamber 40, and inner liner 44 defines an inner boundary of combustion chamber 40. An annular dome 46 is mounted upstream from the outer liner 42 and the inner liner 44, and defines an upstream end of combustion chamber 40. One or more fuel injection systems 48 are positioned on the annular dome 46. In an embodiment, each fuel injection system 48 includes a fuel nozzle assembly 50 and a fuel-air mixer assembly 52 coupled to fuel nozzle assembly 50. The fuel-air mixer assembly 52 comprises an air swirler 53. The fuel-air mixer assembly 52 receives fuel from fuel nozzle assembly 50, receives air from high-pressure compressor assembly 16 (shown in FIG. 1) via a diffuser 54, and discharges a fuel-air mixture 56 into combustion chamber 40 where the mixture is ignited using a fuel ignition assembly 60 and burned. The above combustor 38 is adapted for a partially premix system (TAPS).

FIG. 2B is a cross-sectional view of a portion of a combustor 39 of combustor assembly 18 of the turbine engine 10 of FIG. 1, according to another embodiment of the present disclosure. The combustor 39 is adapted for a rich quick lean (RQL) system. The combustor 39 defines a combustion chamber 41 in which fuel is mixed with compressed air and combusted. Combustor 39 includes an outer liner 43 and an inner liner 45. Outer liner 43 defines an outer boundary of the combustion chamber 40, and inner liner 45 defines an inner boundary of combustion chamber 41. An annular dome 47 extends between and is coupled to the outer liner 43 and the inner liner 45, and defines an upstream end of combustion chamber 41. One or more fuel injection systems 49 are positioned on the annular dome 47. In an embodiment, each fuel injection system 49 includes a fuel nozzle assembly 51 and a fuel-air mixer assembly 55 coupled to the fuel nozzle assembly 51. The fuel-air mixer assembly 55 comprises an air swirler 57. The fuel-air mixer assembly 55 receives fuel from fuel nozzle assembly 51, receives air from high-pressure compressor assembly 16 (shown in FIG. 1) via a diffuser 59, and discharges a fuel-air mixture into combustion chamber 41. In this embodiment, dilution air is introduced primarily into combustion chamber 41 through a plurality of circumferentially spaced dilution holes 58 that extend through each of outer liner 43 and inner liner 45, as shown by the dotted arrows in FIG. 2B, for further mixing with the fuel in combustion chamber 41 where the fuel-air mixture is ignited and burned.

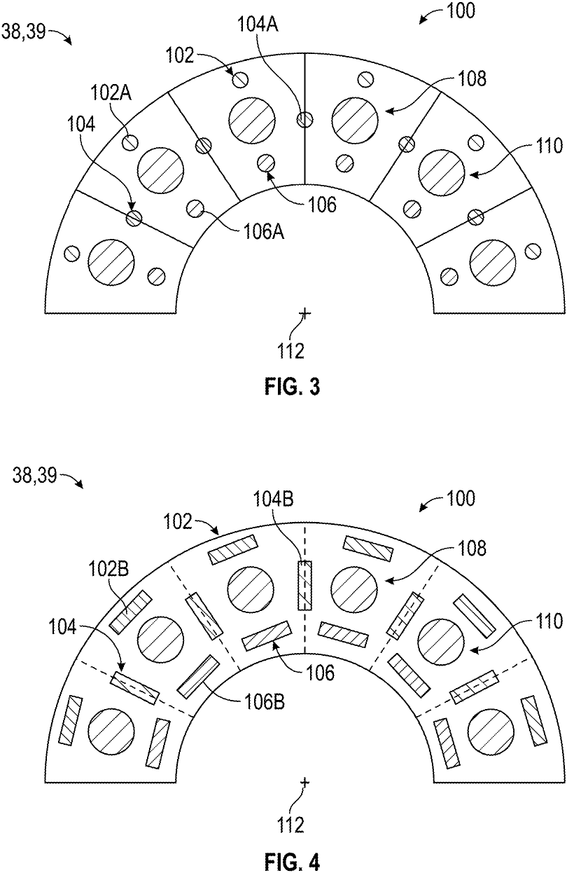

FIG. 3 is a schematic front view of a segment 100 of the combustor 38, 39 showing a location of a plurality of dampers 102, 104, 106, according to an embodiment of the present disclosure. FIG. 4 is a schematic back view of segment 100 of the combustor 38 showing a location of a damper 102, 104, 106, according to an embodiment of the present disclosure. The segment 100 shown in FIGS. 3 and 4 depicts only the back portion of the combustor 38 near the annular dome 46 (shown in FIG. 2). The segment 100 shown in FIGS. 3 and 4 only represents half of the combustor 38. The other half is not shown for clarity purposes. The segment 100 of the combustor 38 has a plurality of heat shields 108. The plurality of heat shields 108 are positioned next to each other. In an embodiment, the plurality of heat shields 108 have a trapezoid shape so that, when assembled, form an annular disk. Each of the plurality of heat shields 108 has a swirler 110. An example of the swirler 110 is shown in FIG. 2 as air swirler 53. The air swirler 53 is part of the fuel-air mixer assembly 52 that is coupled to the fuel nozzle assembly 50. The fuel nozzle assembly 50 and the fuel-air mixer assembly 52 are parts of the fuel injection system 48.

In an embodiment, the segment 100 of the combustor 38 includes the plurality of dampers 102. In an embodiment, the plurality of dampers 102 are positioned at a distal radial distance relative to a center 112 of an annular shape of the segment 100. In an embodiment, the plurality of dampers 102 are located at a distal radial distance relative to a center 112 of the annular dome 46, 47. In another embodiment, the segment 100 of the combustor 38 includes the plurality of dampers 106. In an embodiment, the plurality of dampers 106 are positioned at a proximal distance relative to the center 112 of an annular shape of the segment 100. In an embodiment, the plurality of dampers 102 are located at a proximal distance relative to a center 112 of the annular dome 46, 47. Each of the plurality of dampers 102 or the plurality of dampers 106 is provided within each of the plurality of heat shields 108. In yet another embodiment, the segment 100 of the combustor 38 includes the plurality of dampers 104. In an embodiment, the plurality of dampers 104 are positioned at a median distance relative to the center 112 of an annular shape of the segment 100. In an embodiment, the plurality of dampers 102 are located at a median distance relative to a center 112 of the annular dome 46, 47 between two adjacent portions of the annular dome 46, 47. Each of the plurality of dampers 104 is provided between two adjacent heat shields of the plurality of heat shields 108.

As shown in FIG. 3, in an embodiment, the plurality of dampers 102, 104, 106 have circular openings 102A, 104A, 106A, respectively, on the front side of the segment 100 of the combustor 38, i.e., the side of the combustor 38 facing the combustion chamber 40 of the combustor 38 (shown in FIG. 2). As shown in FIG. 4, in an embodiment, the plurality of dampers 102, 104, 106 have polygonal (e.g., rectangular) openings 102B, 104B, 106B, respectively, on the back side of the segment 100 of the combustor 38, i.e., the side of the combustor 38 facing the diffuser 54 (shown in FIG. 2). As can be understood, any of the configurations using the plurality of dampers 102, the plurality of dampers 104 or the plurality of dampers 106 can be used. For example, in a first implementation, the plurality of dampers 102 are used. In a second implementation, the plurality of dampers 106 are used. In a third implementation, the plurality of dampers 104 are used. In other implementations, however, any combinations of the plurality of dampers 102, plurality of dampers 104 or plurality of dampers 106 can be used.

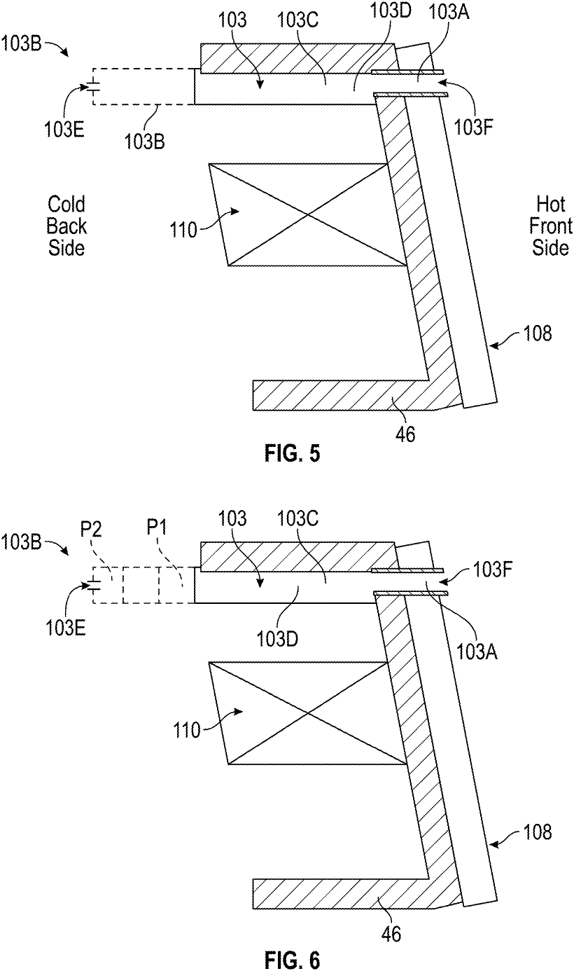

FIG. 5 is a schematic side (cross-sectional) view of the segment 100 of the combustor 38 of FIGS. 3 and 4, showing a location of a damper 103 of plurality of dampers 102, according to an embodiment of the present disclosure. The damper 103 defines a damper cavity 103C integral with the annular dome 46 (also shown in FIG. 2). As shown in FIG. 5, the damper 103 is located at a radial distance above the swirler 110. As shown in FIG. 5, each of the plurality of heat shields 108 is coupled to the annular dome 46. In an embodiment, the plurality of heat shields 108 are located on the hot, front side of annular dome 46. The damper 103 has a damper neck 103A provided through the annular dome 46 and each of the plurality of heat shields 108. The damper neck 103A opens through an opening 103F into the front side, i.e., the side of the combustor 38 facing combustion chamber 40 of the combustor 38, downstream of the swirler 110. In an embodiment, the opening 103F of the damper neck 103A has a round shape, as shown for example in FIG. 4. The damper neck 103A can, however, have any other shape (e.g., oval, polygonal, etc.). The damper 103 has a damper portion 103D that is integrated with the annular dome 46. The damper 103 has a damper cover 103B mounted to the damper portion 103D. Therefore, the damper cover 103B is mounted to the annular dome 46. The damper cover 103B is provided on the cold back side of the combustor 38 facing the diffuser 54. The damper cover 103B together with the damper portion 103D define the damper cavity 103C of the damper 103. The damper cover 103B of the damper 103 is adjustable to modify a total volume of the damper cavity 103C of the damper 103. The damper cavity 103C of the damper 103 is connected to the combustor cold side through one or more purge air holes 103E (of which only one is shown) provided in the damper cover 103B.

FIG. 6 is a schematic side (cross-sectional) view of the segment 100 of the combustor 38 of FIGS. 3 and 4, showing another position of a damper 103 of plurality of dampers 102, according to an embodiment of the present disclosure. As shown in FIG. 6, the damper cover 103B can be extended to a first position P1 to define a first volume for the damper cavity 103C. As shown in FIG. 6, the damper cover can be extended to a second position P2 to define a second volume greater than the first volume for the damper cavity 103C. By adjusting the volume of the damper cavity 103C, a frequency of the damper 103 acting as a Helmholtz resonator can be adjusted, as will be explained further in detail in the following paragraphs.

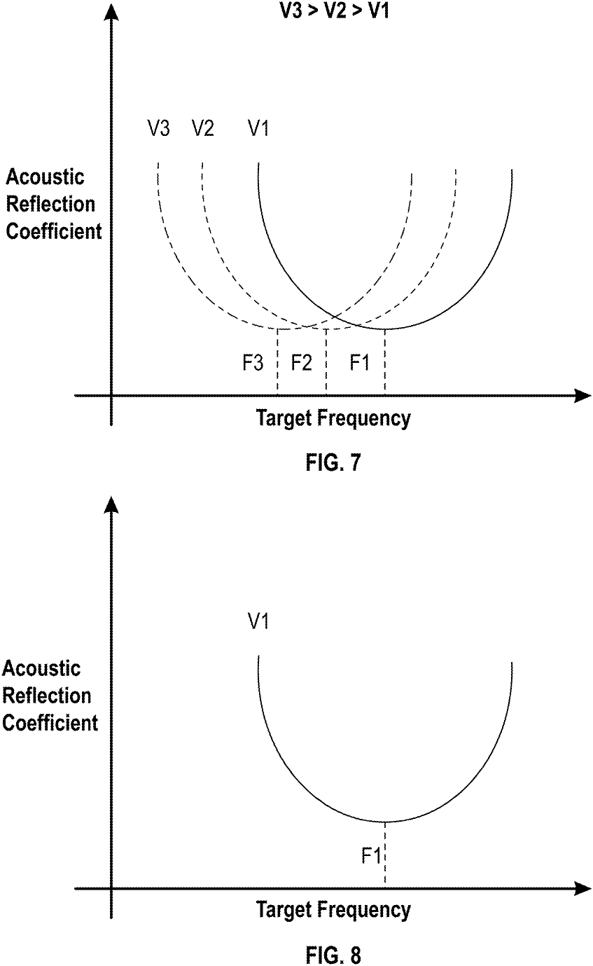

FIG. 7 is a general plot of an acoustic reflection coefficient of the damper 103 of FIGS. 5 and 6, versus a target frequency of the damper 103 acting as a Helmholtz resonator, according to an embodiment of the present disclosure. The curve “V1” corresponds to the acoustic reflection coefficient versus the target frequency of the damper 103 when the damper cavity 103C has a first volume V1. The curve “V2” corresponds to the acoustic reflection coefficient versus the target frequency of the damper 103 when the damper cavity 103C has a second volume V2. The curve “V3” corresponds to the acoustic reflection coefficient versus the target frequency of the damper 103 when the damper cavity 103C has a third volume V3. Volume V3 is greater than volume V2, which is greater than volume V1 (i.e., V3>V2>V1). The curves “V1”, “V2”, and “V3” show a minimum of the acoustic reflection coefficient at a certain target frequency. The minimum for curve “V1” for volume V1 occurs at frequency F1. The minimum for curve “V2” for volume V2 occurs at frequency F2. The minimum for curve “V3” for volume V3 occurs at frequency F3. The frequency F1 is greater than the frequency F2, which is greater than the frequency F3 (i.e., F1>F2>F3). Therefore, the greater the volume of the cavity 103C of the damper 103, the lower the frequency of the damper 103.

FIG. 8 is a general plot of an acoustic reflection coefficient of the total volume of the damper cavity 103C of the damper 103 versus a target frequency of the damper 103 acting as a Helmholtz resonator for a specific volume of the damper cavity 103C of the damper 103, according to an embodiment of the present disclosure. This plot represents the damper performance as a function of frequency. The curve “V1” in this plot corresponds to the acoustic reflection coefficient versus the target frequency of the damper 103 when the damper cavity 103C has a first volume V1. The minimum for curve “V1” for volume V1 occurs at frequency F1. The minimum of the acoustic reflection response indicates that the acoustic vibration is maximally damped at the frequency F1.

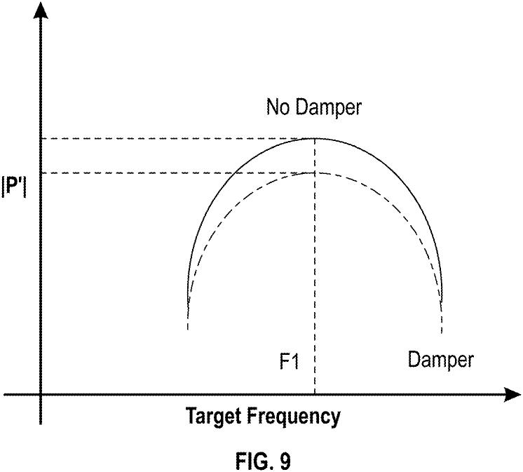

FIG. 9 is a general numerical plot of acoustic pressure response of the combustor 38 of FIGS. 3 and 4, versus a target frequency with and without the plurality of dampers 102, according to an embodiment of the present disclosure. The curve labeled “No Damper” corresponds to a pressure response of the combustor 38 as a function of frequency without using the plurality of dampers 102. The curve labeled “Damper” corresponds to a pressure response of the combustor 38 as a function of frequency when using the plurality of dampers 102. The plurality of dampers 102 are tuned to the frequency F1. As shown in FIG. 8, when using the plurality of dampers 102, the acoustic pressure P′ can be reduced. Although the pressure or acoustic response is shown reduced in the combustor 38 when using the plurality of dampers 102, the plurality of dampers 104 and/or the plurality of dampers 106 can perform equally and can be used to reduce the pressure fluctuation in the combustor 38. In an embodiment, the reduction observed using the plurality of dampers 102, 104, and/or 106 may go up to 50%, i.e., between 0% and 50%, of unstable pressure oscillation.

As can be appreciated from the above paragraphs, the plurality of dampers 102, 104, 106 acting as Helmholtz resonators, allow to reduce acoustic pressure oscillation. By using the tuned air cavity of the plurality of dampers 102, 104, 106, unexpected occurrence of high acoustic pressure oscillations in the combustion chamber can be reduced. As a result, operational and structural robustness of the combustor 38 can be enhanced. In addition, by providing an airflow through the damper neck 103A in each of one or more purge air holes 103E of dampers 102, 104, 106, damping performance of the damper cavity 103C can be increased. As shown in FIGS. 3 to 6, the damper neck 103A providing additional purge air flow can be fully integrated with the annular dome 46.

By integrating the cavity 103C, the damper neck 103A and the damper cover 103B of the damper 103 within the annular dome 46 (See FIG. 2A), fewer parts are used and the overall weight of the combustor 38 can be decreased in comparison with conventional damper configurations. The integration can be accomplished by utilizing unused space under the annular dome 46. In addition to the adjustability of the volume of the damper cavity 103C (provided by the adjustability of the volume within the damper cover 103B), which provides tuning the frequency response of the damper 103, the additional purge air flow provided by the damper neck 103A can also be configured to enable tuning the frequency within a certain frequency range. Based on identified unstable frequencies, the damper target frequency can be adjusted and the acoustic pressure oscillations can be reduced.

The above plurality of dampers 102, 104, 106 can be integrated into the combustor 38 of FIGS. 3 and 4. The plurality of dampers 102, 104, 106 can be fully integrated with the annular dome 46, 47 as being its structural part. This configuration is lightweight and compact, which facilitates its use in aviation engines. In addition, tuning the plurality of dampers can be easily accomplished by changing or varying the volume of the damper cavity 103C (i.e., varying the volume within the damper cover 103B by moving the damper cover 103B relative to the fixed damper portion 103D) of each damper 103 in the plurality of dampers 102, 104, 106. The volume of the damper cavity 103C can be tuned or varied by moving the damper cover 103B relative to the damper portion 103D. The damper cavity 103C of the damper 103 is located on a “colder” side of the annular dome 46 while the damper 103 is connected to the “hotter” side of the annular dome 46 via the damper neck 103A to provide a link between an acoustic source in combustion chamber 40 of the combustor 38 and sink or damp the acoustic amplitude. The addition of the plurality of dampers 102, 104, 106 to the combustor 38 extends the lifespan of combustor 38 while providing an additional mechanically stiffer annular dome 46 or 47. The configuration described above can be incorporated into existing operating engines or provided in newly manufactured engines.

As can be appreciated from the discussion above, a combustor is provided. The combustor includes an annular dome, and a plurality of dampers integral with the annular dome. Each of the plurality of dampers includes an adjustable damper cover and a damper portion defining a cavity having a volume. The damper cover is mounted to the damper portion, integrated with the annular dome and is movable to adjust the volume of the cavity to adjust a frequency of each of the plurality of dampers to reduce an acoustic amplitude of the combustor.

The combustor according to the above clause, wherein the plurality of dampers are located at a distal radial distance relative to a center of the annular dome.

The combustor according to any of the above clauses, wherein the plurality of dampers are located at a proximal distance relative to a center of the annular dome.

The combustor according to any of the above clauses, wherein the plurality of dampers are located at a median distance relative to a center of the annular dome between two adjacent portions of the annular dome.

The combustor according to any of the above clauses, wherein the combustor further including a plurality of heat shields coupled the annular dome and located on a hotter front side of the annular dome. The damper neck is provided through a heat shield in the plurality of heat shields.

The combustor according to any of the above clauses, wherein the damper neck has an opening that open to the hotter front side of the annular dome.

The combustor according to any of the above clauses, wherein the damper cover is located at a colder back side of the combustor.

The combustor according to any of the above clauses, wherein the greater the volume of the cavity, the lower the frequency of the damper.

The combustor according to any of the above clauses, further including an inner liner and an outer liner defining a boundary of a combustion chamber. The annular dome is mounted upstream from the outer liner and the inner liner, and defines an upstream end of combustion chamber.

The combustor according to any of the above clauses, further including one or more fuel injection systems positioned on the annular dome, the one or more fuel injection systems comprising a fuel nozzle assembly and a fuel-air mixer assembly coupled to fuel nozzle assembly. The fuel-air mixer assembly receives fuel from fuel nozzle assembly, receives air, and discharges a fuel-air mixture into the combustion chamber where the fuel-air mixture is ignited and burned.

According to another aspect of the present disclosure, a turbine engine includes a combustor having an annular dome, and a plurality of dampers integral with the annular dome. Each of the plurality of dampers includes an adjustable damper cover and a damper portion defining a cavity having a volume. The damper cover is mounted to the damper portion integrated with the annular dome and is movable to adjust the volume of the cavity to adjust a frequency of each of the plurality of dampers to reduce an acoustic amplitude of the combustor.

The turbine engine according to the above clause, wherein the plurality of dampers are located at a distal radial distance relative to a center of the annular dome.

The turbine engine according to any of the above clauses, wherein the plurality of dampers are located at a proximal distance relative to a center of the annular dome.

The turbine engine according to any of the above clauses, wherein the plurality of dampers are located at a median distance relative to a center of the annular dome between two adjacent portions of the annular dome.

The turbine engine according to any of the above clauses, the combustor further including a plurality of heat shields coupled the annular dome and located on a hotter, front side of the annular dome. The damper neck is provided through a heat shield in the plurality of heat shields.

The turbine engine according to any of the above clauses, wherein the damper neck has an opening that open to the hotter front side of the annular dome.

The turbine engine according to any of the above clauses, wherein the damper cover is located at a colder back side of the combustor.

The turbine engine according to any of the above clauses, wherein the greater the volume of the cavity, the lower the frequency of the damper.

The turbine engine according to any of the above clauses, further including an inner liner and an outer liner defining a boundary of a combustion chamber. The annular dome is mounted upstream from the outer liner and the inner liner, and defines an upstream end of combustion chamber.

The turbine engine according to any of the above clauses, further including one or more fuel injection systems positioned on the annular dome, the one or more fuel injection systems comprising a fuel nozzle assembly and a fuel-air mixer assembly coupled to fuel nozzle assembly. The fuel-air mixer assembly receives fuel from fuel nozzle assembly, receives air, and discharges a fuel-air mixture into the combustion chamber where the fuel-air mixture is ignited and burned.

Although the foregoing description is directed to the preferred embodiments of the present disclosure, it is noted that other variations and modifications will be apparent to those skilled in the art, and may be made without departing from the spirit or scope of the disclosure. Moreover, features described in connection with one embodiment of the present disclosure may be used in conjunction with other embodiments, even if not explicitly stated above.

We claim:

1. A combustor comprising:
an annular dome; and
a plurality of dampers integral with the annular dome, each of the plurality of dampers comprising an adjustable damper cover and a damper portion integrated with the annular dome and defining a cavity having a volume, wherein the damper cover is mounted to the damper portion and movable to adjust the volume of the cavity to adjust a frequency of each of the plurality of dampers to reduce an acoustic amplitude of the combustor.

2. The combustor according to claim 1, wherein the plurality of dampers are located at a distal radial distance relative to a center of the annular dome.

3. The combustor according to claim 1, wherein the plurality of dampers are located at a proximal distance relative to a center of the annular dome.

4. The combustor according to claim 1, wherein the plurality of dampers are located at a median distance relative to a center of the annular dome between two adjacent portions of the annular dome.

5. The combustor according to claim 1, wherein the damper cover is located on a back side of the combustor.

6. The combustor according to claim 1, wherein the greater the volume of the cavity, the lower the frequency of the damper.

7. The combustor according to claim 1, further comprising a plurality of heat shields coupled to the annular dome and located on a front side of the annular dome, wherein the damper neck is provided through a heat shield of the plurality of heat shields.

8. The combustor according to claim 7, wherein the damper neck has an opening that opens to the front side of the annular dome.

9. The combustor according to claim 1, further comprising an inner liner and an outer liner defining a boundary of a combustion chamber, wherein the annular dome is mounted upstream from the outer liner and the inner liner, and defines an upstream end of combustion chamber.

10. The combustor according to claim 9, further comprising one or more fuel injection systems positioned on the annular dome, the one or more fuel injection systems comprising a fuel nozzle assembly and a fuel-air mixer assembly coupled to fuel nozzle assembly, wherein the fuel-air mixer assembly receives fuel from fuel nozzle assembly, receives air, and discharges a fuel-air mixture into the combustion chamber where the fuel-air mixture is ignited and burned.

11. A turbine engine comprising:
a combustor comprising:
(a) an annular dome; and
(b) a plurality of dampers integral with the annular dome, each of the plurality of dampers comprising an adjustable damper cover and a damper portion integrated with the annular dome and defining a cavity having a volume, wherein the damper cover is mounted to the damper portion and movable to adjust the volume of the cavity to adjust a frequency of each of the plurality of dampers to reduce an acoustic amplitude of the combustor.

12. The turbine engine according to claim 11, wherein the plurality of dampers are located at a distal radial distance relative to a center of the annular dome.

13. The turbine engine according to claim 11, wherein the plurality of dampers are located at a proximal distance relative to a center of the annular dome.

14. The turbine engine according to claim 11, wherein the plurality of dampers are located at a median distance relative to a center of the annular dome between two adjacent portions of the annular dome.

15. The turbine engine according to claim 11, wherein the damper cover is located on a back side of the combustor.

16. The turbine engine according to claim 11, wherein the greater the volume of the cavity, the lower the frequency of the damper.

17. The turbine engine according to claim 11, further comprising a plurality of heat shields coupled to the annular dome and located on a front side of the annular dome, wherein the damper neck is provided through a heat shield of the plurality of heat shields.

18. The turbine engine according to claim 17, wherein the damper neck has an opening that opens to the front side of the annular dome.

19. The turbine engine according to claim 11, further comprising an inner liner and an outer liner defining a boundary of a combustion chamber, wherein the annular dome is mounted upstream from the outer liner and the inner liner, and defines an upstream end of combustion chamber.

20. The turbine engine according to claim 19, further comprising one or more fuel injection systems positioned on the annular dome, the one or more fuel injection systems comprising a fuel nozzle assembly and a fuel-air mixer assembly coupled to fuel nozzle assembly, wherein the fuel-air mixer assembly receives fuel from fuel nozzle assembly, receives air, and discharges a fuel-air mixture into the combustion chamber where the fuel-air mixture is ignited and burned.
